(19) United States
(12) Patent Application Publication
(10) Pub. No.: US 2005/0000550 A1
(43) Pub. Date: Jan. 6, 2005

(54) METHOD FOR BACKFLUSHING INJECTOR NEEDLES

(75) Inventors: Edwin O. Fick JR., Sioux City, IA (US); Kris Parker, Persia, IA (US)

Correspondence Address: BLACKWELL SANDERS PEPER MARTIN LLP, 720 OLIVE STREET, SUITE 2400, ST. LOUIS, MO, 63101, US

(73) Assignee: TYSON FRESH MEATS, INC., Dakota Dunes, SD (US)

(21) Appl. No.: 10/604,218

(22) Filed: Jul. 1, 2003

(51) Int. Cl. B08B 3/00; B08B 9/00; B08B 7/04

(52) U.S. Cl. 134/30; 134/22.12; 134/22.15; 134/37

(57) ABSTRACT

A method for cleaning a plurality of injector needles is disclosed. The method comprises exposing the plurality of injector needles to a cleaning solution, removing the plurality of injector needles from the cleaning solution, and exposing simultaneously the hollow interior shaft of each injector needle to a gaseous stream. The gaseous stream removes any moisture and fine particles that remain in the plurality of injector needles after the injector needles are cleaned. In one embodiment the injector needle's hollow interior shaft is of a lesser diameter at the tip than at the head of the injector needle. The gaseous stream is directed into the injector needle through the tip and exits the needle through the head, thereby simultaneously backflushing the injector needles.

### BACKGROUND OF INVENTION

The use of injection methods in the food industry is well known. Injector needle technology allows a multitude of liquids and fine particles including flavorings and/or preservatives to be injected into meats, poultry and fish, as well as other foodstuffs. The injection is accomplished by injector machines such as those marketed by Metalquimia of Girona, Spain. As with all equipment utilized to handle or manipulate food items, the injector needles must be cleaned meticulously to meet government and industry standards. Several apparatus for cleaning a plurality of injector needles are known in the art. One method includes the use of a stream of compressed air to dry the interior of the injector needle. An example of this method utilizes a Metalquimia Needle Blow Tube. Unfortunately, this process involves manually connecting each individual injector needle to the Needle Blow Tube. This method is quite time consuming, as it typically takes at least six seconds to dry each injector needle.

It is therefore desirable to provide a method that allows a plurality of injector needles to be dried simultaneously.

### SUMMARY OF INVENTION

In one aspect of the present invention a method for cleaning a plurality of injector needles, each injector needle having at least one hollow interior shaft, is provided. The method comprises exposing the plurality of injector needles to a cleaning solution, removing the plurality of injector needles from the cleaning solution, and exposing simultaneously the at least one hollow interior shaft of each injector needle to a gaseous stream. The gaseous stream removes any moisture and fine particles that remain in the plurality of injector needles after the injector needles are cleaned.

In another aspect of the present invention a method is disclosed for backflushing injector needles wherein each injector needle includes a head at one end of the injector needle and a tip at the opposite end of the injector needle. Each injector needle includes at least one interior shaft that is of a lesser diameter at the tip than at the head. The gaseous stream simultaneously enters the plurality of injector needles through the tips and exits the plurality of injector needles through the heads, thereby simultaneously backflushing the interior of the injector needles.

These are merely illustrative aspects of the present invention and should not be deemed an all-inclusive listing of the innumerable aspects associated with the present invention. These and other aspects will become apparent to those skilled in the art in light of the following disclosure.

### BRIEF DESCRIPTION OF DRAWINGS

FIG. 1 is a top view of a needle board designed to hold 260 injector needles.

FIG. 2 is a cross-sectional view of the needle board of FIG. 1.

FIG. 3 is a cross-sectional view of an embodiment of an injector needle cleaning apparatus.

FIG. 4 is a top view of an embodiment of the cleaning apparatus of FIG. 3 designed to hold four needle boards of FIG. 1.

FIG. 5 is a cross-sectional view of an embodiment of an injector needle backflushing apparatus.

FIG. 6 is a top of the embodiment of an injector needle backflushing apparatus of FIG. 5, shown with the needle board of FIG. 1 removed.

FIG. 7 is a top view of an injector needle alignment board designed for 260 injector needles.

FIG. 8 is a cross-sectional view of the alignment board of FIG. 7.

### DETAILED DESCRIPTION

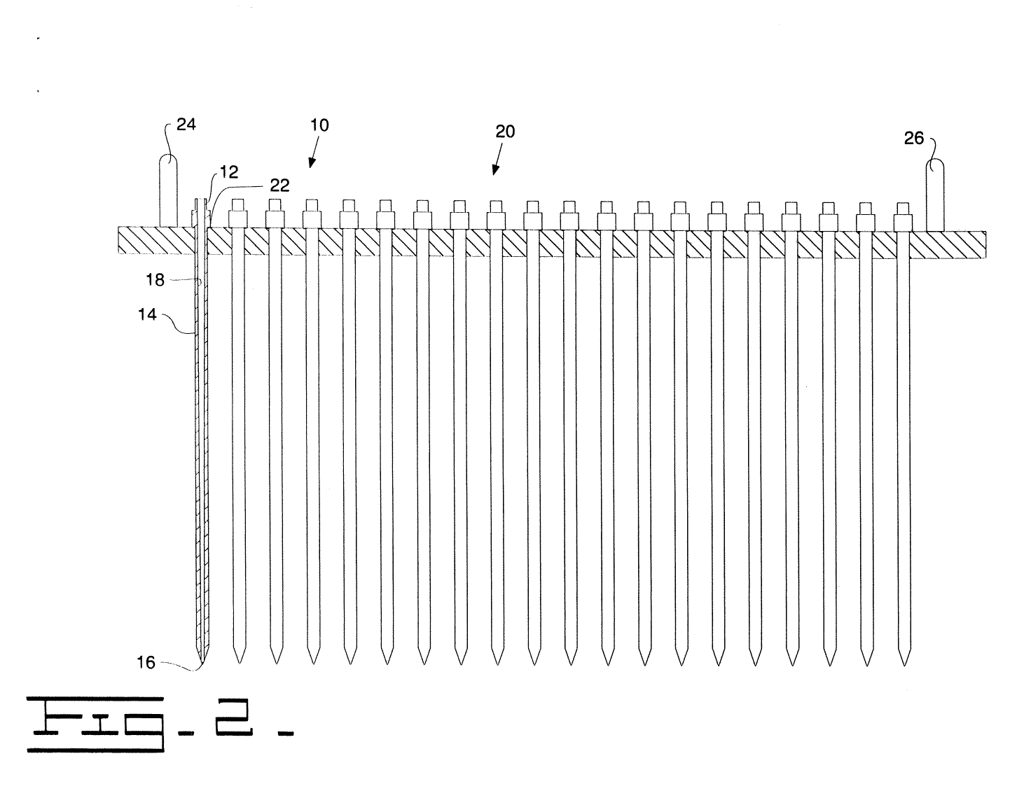

The injection or injector needles utilized for injecting liquids into meats and other foodstuffs vary according to the application, but include single and multiple orifice injector needles, and are generally made of stainless steel. A typical injector needle, shown for illustrative purposes only, is seen in FIG. 2. The injector needle, generally designated 10 includes a head 12 at one end, a tip 16 at the opposite end, and a shaft 14. The injector needle further includes at least one interior hollow shaft 18. In this illustrative embodiment, the diameter of the interior shaft 18 is less at the tip 16 than at the head 12.

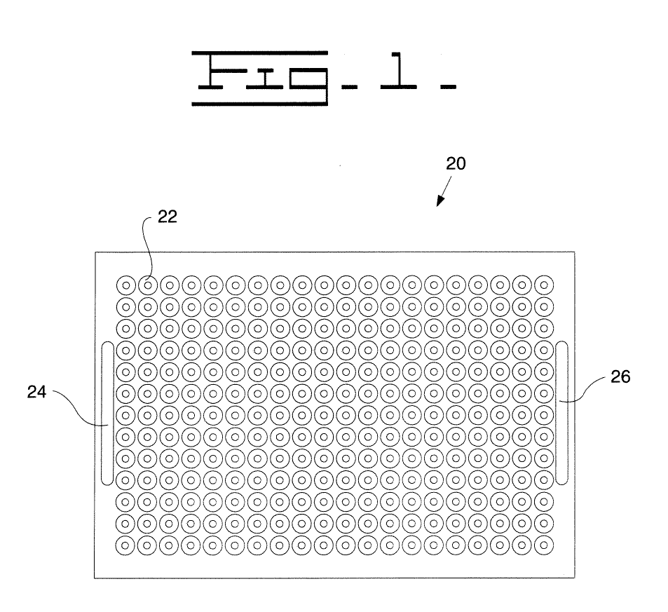

FIGS. 1 and 2 show a needle board generally designated 20. The needle board 20 can be of any shape and size as desired by the user, and configured to fit into the particular cleaning and backflushing apparatus, as discussed below. The illustrated needle board 20 includes 260 holes 22 designed to hold the injector needles 10. The needle board 20 may be made of any suitable material, including synthetic material such as nylon. A suitable material is Delron White Board. The diameter of the holes 22 is such that the tip 16 and shaft 14 of the injector needles 10 are slipped through the hole 22, while the head 12 prevents the injector needles 10 from falling through the needle board 20. The needle board 20 is therefore specific for injector needles 10 of a particular diameter; separate needle boards 20 are required for each diameter injector needle 10 to be cleaned. The illustrative board 20 further includes optional handles 24, 26 to facilitate the placement of the needle board.

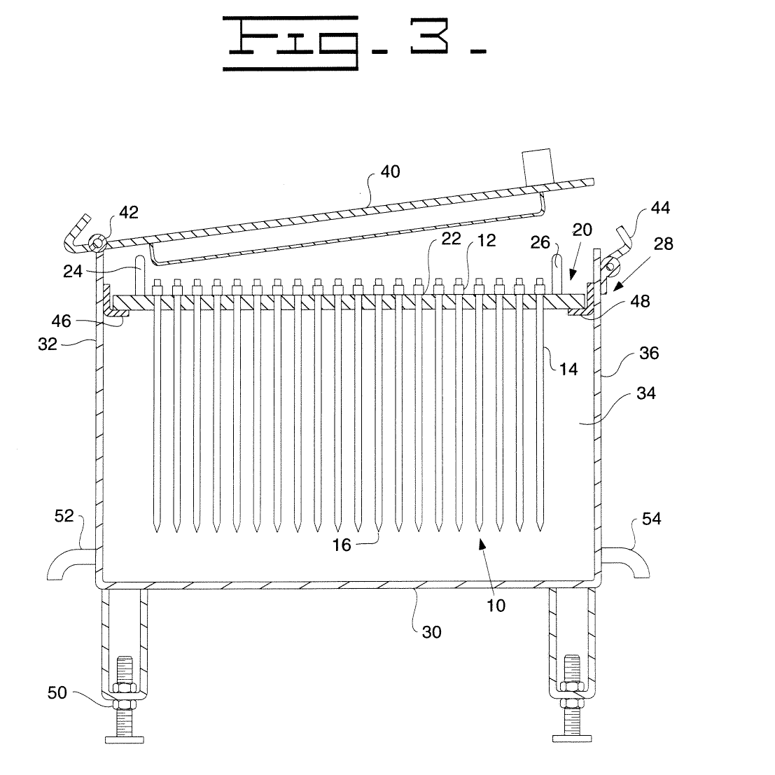

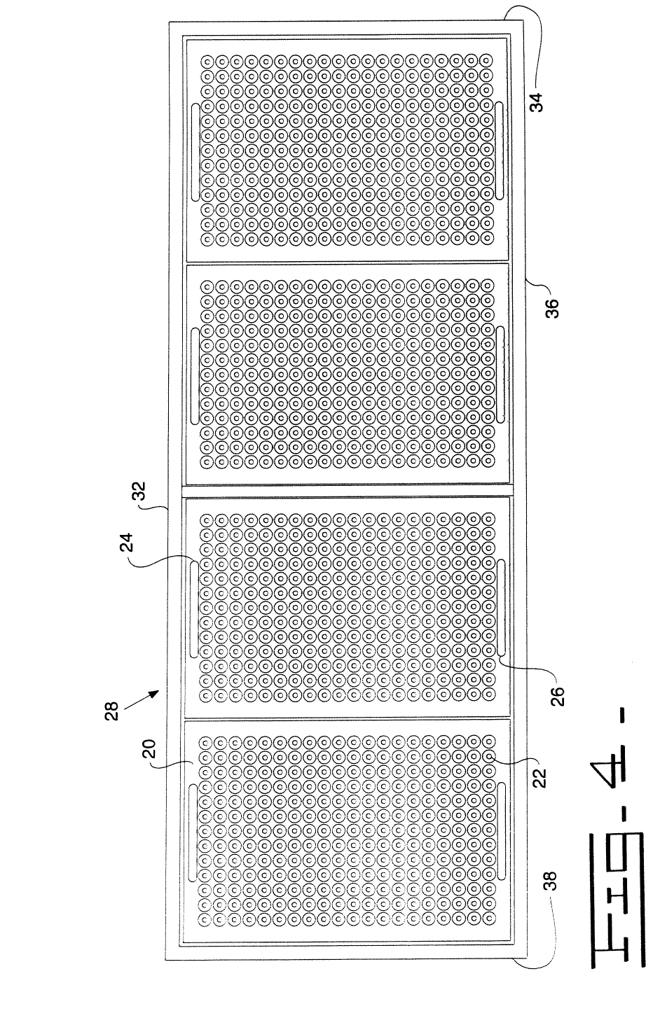

FIGS. 3 and 4 are an illustrative example of a needle cleaning apparatus, generally designated 28. This type of cleaning apparatus 28 is well known in the art, and suitable models are commercially available from sources such as Metalquimia of Girona, Spain. The cleaning apparatus 28 can be designed to accept one or more needle boards 20 of the dimensions desired for the particular application. An apparatus 28 for cleaning four needle boards 20 of 260 injector needles is illustrated.

In the illustrative example the cleaning apparatus consists of a bottom 30, side sections 32, 34, 36 and 38 and a cover or lid 40. The cover 40 is connected to side 32 by hinge or hinges 42, and held in place by a latch 44 when the cover 40 is in the closed position. This allows the cover 40 to be lifted to allow insertion and removal of the needle board or boards 20. When the board or boards 20 are inserted they rest on flanges 46, 48 so that the injector needles 10 do not come in contact with the bottom 30 of the apparatus. The length of the particular injector needles 10 is therefore a design consideration. Leveling means 50 are typically included to insure the injector needles 10 remain substantially vertical to prevent damage from contact with the sides 32, 34, 36 and 38 of the apparatus.

The cleaning apparatus 28 includes at least one fluid port, and typically at least one inlet 52 and at least one outlet 54 to allow cleaning solutions and rinse water to be introduced and evacuated. This type of apparatus 28 may further include any number of additional components such as agitation means, heating means, and or temperature controls, not shown. The apparatus 28 may be run manually or be automated, as is well known in the art.

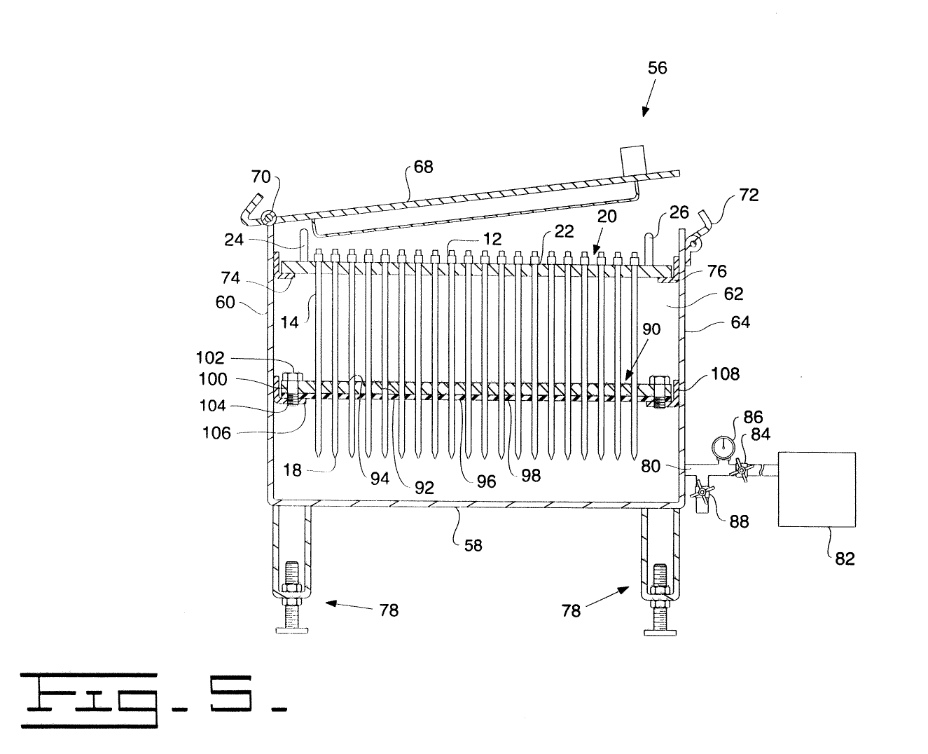

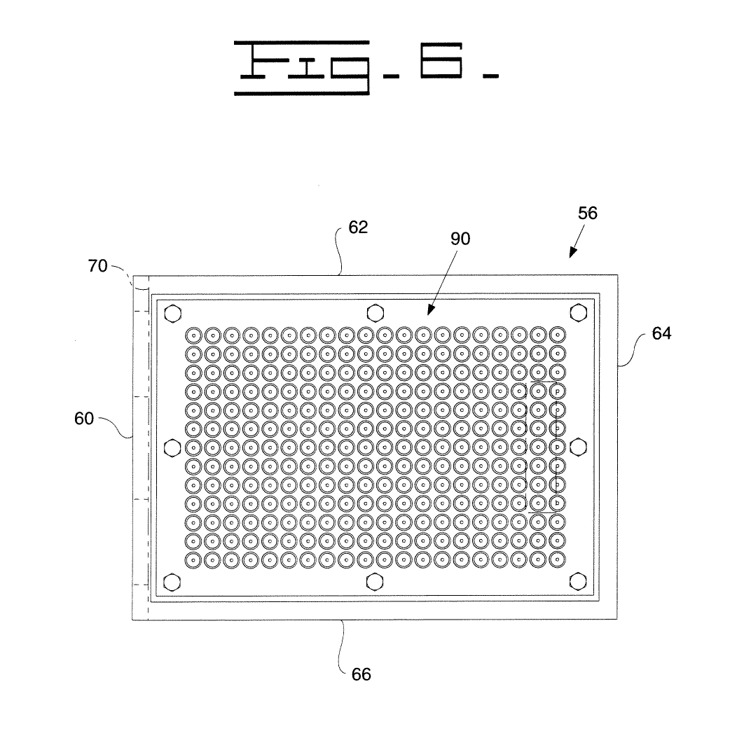

FIGS. 5 and 6 are of an illustrative embodiment of a needle backflushing apparatus 56 suitable for use with the present method. As with the cleaning apparatus 28 discussed above, the needle backflushing apparatus 56 may be designed to hold one or more needle boards 20 of the dimensions desired for the particular application. This illustrative example holds a single board 20 of 260 injector needles.

The needle backflushing apparatus 56 includes a bottom 58, sides 60, 62, 64 and 66, and a cover or lid 68. The cover 68 is connected to the side 60 by hinge or hinges 70 and is secured by latch 72 when cover 68 is in the closed position. As with the cleaning apparatus 28, flanges 74, 76 hold the needle board or boards 20 when they are placed into the backflushing apparatus 56, and a leveling means 78 is preferably included. At least one inlet 80 is in fluid communication with a means for producing a gaseous stream, typically a compressor 82, valve 84, pressure monitor 86 and a release valve 88. As this apparatus is merely illustrative, any number of additional features may be added, as is well known in the art.

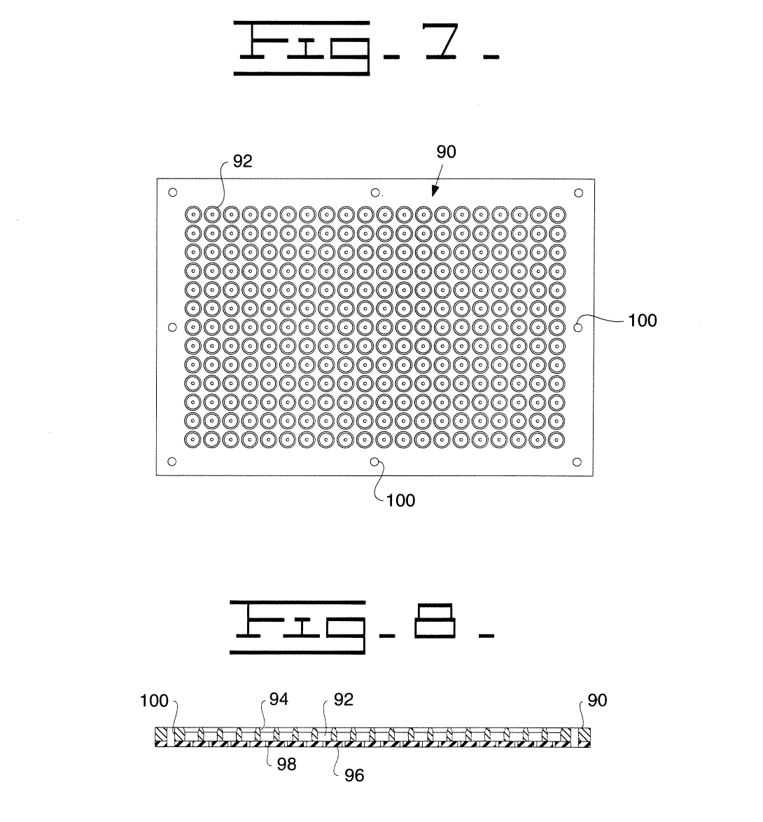

The needle backflushing apparatus 56 further includes a needle alignment board, generally designated 90, better seen in FIGS. 7 and 8. As with the needle board 20, the needle alignment board 90 may be made of any suitable material, including synthetic material such as nylon. The needle alignment board 90 includes holes 92 that correspond to the holes 22 in the needle board 20. The holes 92 include a beveled edge 94 to guide the injector needles 10 into holes 92. A sealing layer 96 of gasket-like material is attached by any suitable means to the side of the needle alignment board 90 opposite the beveled edge 94. In this illustrative example sealing layer 96 is 1/16 inch thick neoprene, but any suitable USDA approved material may be used. The injector needles 10 pass through holes 98 in layer 96, and once fully inserted the sealing layer 96 secures around the injector needles 10. The needle alignment board 90 includes apertures 100 through which bolts 102 engage corresponding apertures 104 in support flanges 106, 108, although needle alignment board 90 may be secured in place by any suitable method.

In an alternative embodiment not illustrated, the needle alignment board 90 holes 92 may include O-rings to seal about the injector needles 10 in place of the sealing layer 96.

In operation, the injector needles 10 are placed into the holes 22 of needle board 20. This is typically done before needle board 20 is placed into cleaning apparatus 28, but this is not critical to the present method. The needle boards 20 are then inserted into the cleaning apparatus 28 and the cover 40 is secured. The injector needles 10 are then cleaned by any conventional method, typically a protocol as designed by the injector needle 10 manufacturer, as is well known in the art.

In an illustrative example the injector needles 10 are exposed to a cleaning solution that is introduced into the cleaning apparatus 28 through inlet 52, with or without agitation, and then drained from the cleaning apparatus 28 through outlet 54. Suitable agitation means include but are not limited to the use of steam or a recycle pump. A rinse cycle typically follows. The needle boards 20 holding the cleaned injector needles 10 are then removed from the cleaning apparatus 28 and placed into the needle backflushing apparatus 56.

As the needle boards 20 are inserted into the backflushing apparatus 56, the beveled edge 94 guides the injector needles 10 into holes 92, and the sealing layer 96 creates a seal about the injector needles 10. The cover 68 is closed and secured, or other means are provided to prevent the injector needles 10 from being ejected from backflushing apparatus 56 when the air source is engaged. The compressor 82 is turned on and a stream of air is forced in through inlet 80. Because of the seal created around the injector needles 10 by the sealing layer 96, substantially the only path for the gaseous stream is in through the injector needle tips 16, and out through the injector needle heads 12. This backflushes the injector needles 10, since the interior diameter of shaft 18 is less at the tip 16 than at the head 12. The injector needles 10 are thereby dried, and any fine particles present are forced out through the head 12 of the injector needles 10.

In an illustrative example utilizing the backflush apparatus 56 described herein, a two inch air valve 84 is opened for 5 to 7 seconds. The air stream is filtered, by a 1 micron filter, for example, to prevent the introduction of foreign material into the backflush apparatus 56 and the injector needles 10. An inlet air pressure of 120 psig typically creates a satisfactory backflush.

While embodiments of a needle board, a cleaning apparatus and a backflushing apparatus have been disclosed for purposes of illustration, the method of the present invention is in no way intended to be limited by these disclosures. The needle board may be of any size, shape or design, or the injector needles may be positioned in a different way without departing from the method of the present invention.

The cleaning apparatus may be of any size, shape or design, so long as the injector needles are cleaned to the desired specifications. The backflushing apparatus may be of any size, shape or design, so long as a substantial portion of an air stream is directed to flow simultaneously through the interior shafts of a plurality of injector needles.

In addition, the backflushing method of the present invention may be applied to cleaning other types of needles in addition to injector needles.

Having described the invention in detail, those skilled in the art will appreciate that modifications may be made of the invention without departing from its spirit and scope.

Therefore, it is not intended that the scope of the invention be limited to the specific embodiments described.

Rather, it is intended that the appended claims and their equivalents determine the scope of the invention.

1. A method for cleaning a plurality of needles, each needle having at least one hollow interior shaft, the method comprising:
exposing the plurality of needles to a cleaning solution;
removing the plurality of needles from the cleaning solution; and
exposing simultaneously the at least one hollow interior shaft of each needle to a gaseous stream.

2. The method for cleaning of claim 1 further including rinsing the needles to remove the cleaning solution prior to exposing simultaneously the at least one hollow interior shaft of each needle to a gaseous stream.

3. The method of claim 1 wherein each needle includes a head at one end of the needle and a tip at the opposite end of the needle, wherein the at least one interior shaft is of a lesser diameter at the tip than at the head, and wherein the gaseous stream enters the plurality of needles through the tip and exits the plurality of needles through the head.

4. A method for cleaning a plurality of injector needles, each injector needle having a head at one end of the injector needle, a tip at the opposite end of the injector needle and at least one hollow interior shaft, wherein the at least one interior shaft is of a lesser diameter at the tip than at the head, the method comprising:
inserting the plurality of injector needles into a needle board having a plurality of holes into which the plurality of injector needles are individually placed;
exposing the plurality of injector needles to a cleaning solution;
inserting the needle boards into a means for simultaneously exposing the at least one interior shaft of each injector needle of the plurality of injector needles to a gaseous stream; and
simultaneously exposing the at least one interior shaft of each injector needle of the plurality of injector needles to a gaseous stream.

5. The method of claim 4 further including placing the needle board holding the plurality of injector needles into a means for cleaning the injector needles prior to exposing the injector needles to the cleaning solution and removing the needle board from the means for cleaning after exposing the injector needles to the cleaning solution.

6. The method of claim 5 further including rinsing the injector needles to remove the cleaning solution prior to removing the needle board from the means for cleaning.

7. The method of claim 5 wherein more than one needle board is inserted into the means for cleaning.

8. The method of claim 4 further including positioning the plurality of injector needles into the means for exposing the at least one interior shaft of each needle of the plurality of injector needles to a gaseous stream so that the gaseous stream enters the injector needles at the tip and exits the injector needles at the head, thereby simultaneously backflushing the plurality of injector needles.

9. A method for cleaning a plurality of injector needles, each injector needle having a head at one end of the injector needle, a tip at the opposite end of the injector needle and at least one hollow interior shaft, wherein the at least one hollow interior shaft is of a lesser diameter at the tip than at the head, the method comprising:
inserting the plurality of injector needles into a needle board having a plurality of holes into which the plurality of injector needles are individually placed;
placing the needle board holding the plurality of injector needles into a means for cleaning the injector needles;
exposing the plurality of injector needles to a cleaning solution;
rinsing the plurality of injector needles to remove the cleaning solution;
removing the needle board from the means for cleaning;
inserting the needle board into a means for simultaneously backflushing the plurality of injector needles, the means for backflushing including a gaseous stream source for producing a gaseous stream;
positioning the plurality of injector needles so that the gaseous stream enters the plurality of injector needles at the tip and exits the plurality of injector needles at the head; and
backflushing simultaneously the plurality of injector needles by forcing the gaseous stream through the plurality of injector needles.

10. The method of claim 9 wherein the plurality of injector needles are multioraficed injector needles.

11. The method of claim 9 wherein more than one needle board is inserted into the cleaning means.

12. The method of claim 9 wherein more than one needle board is inserted in the means for backflushing simultaneously the plurality of injector needles.
